(19) United States
(12) Patent Application Publication
(10) Pub. No.: US 2026/0336440 A1
(43) Pub. Date: Oct. 29, 2026

(54) CHARGING GUN ADAPTER AND CHARGING EQUIPMENT

(71) Applicant: LITE-ON TECHNOLOGY CORPORATION, TAIPEI CITY (TW)

(72) Inventors: GUAN-YI WU, TAIPEI CITY (TW); Yu-Ming Hsu, TAIPEI CITY (TW)

(21) Appl. No.: 19/250,094

(22) Filed: Jun. 26, 2025

(30) Foreign Application Priority Data
Apr. 28, 2025 (CN) 202520821275.5

(51) Int. Cl. B60L 53/16; B60L 53/31; H01R 13/713; H01R 31/06

(52) U.S. Cl. CPC B60L 53/16; B60L 53/31; H01R 13/7137; H01R 31/065

(57) ABSTRACT

A charging gun adapter and a charging equipment. The charging equipment includes a charging body, a charging gun that is connected to the charging body, and a charging gun adapter that is electrically coupled to the charging gun. The charging gun adapter includes a housing, a first connection structure that is disposed in the housing, a second connection structure that is disposed in the housing, and a temperature protection structure. The first connection structure is electrically coupled to the second connection structure to form a line unit. When a temperature detected by the temperature protection structure is greater than a threshold value, the temperature protection structure and the line unit form a short circuit.

### CROSS-REFERENCE TO RELATED PATENT APPLICATION

This application claims the benefit of priority to China Patent Application No. 202520821275.5, filed on Apr. 28, 2025, in the People’s Republic of China. The entire content of the above identified application is incorporated herein by reference.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to an adapter and charging equipment, and more particularly to a charging gun adapter and charging equipment.

### BACKGROUND OF THE DISCLOSURE

A battery module of a conventional electric vehicle needs to be charged to replenish electric power. Currently, main charging methods for the electric vehicle include alternating current (AC) charging and direct current (DC) charging. AC charging typically requires a longer charging time and is commonly referred to as "slow charging," while DC charging requires a shorter charging time and is commonly referred to as "fast charging."

However, in conventional charging gun devices (or charging gun adapters), if there is poor contact between the charging plug and the charging socket during the charging process due to the presence of foreign objects (e.g., metal wires or hair), water ingress, or manufacturing tolerances, the temperature can rapidly increase and potentially cause fire hazards. This constitutes a major safety issue that must be carefully considered during the charging of electric vehicles.

### SUMMARY OF THE DISCLOSURE

In response to the above-referenced technical inadequacy, the present disclosure provides a charging gun adapter and charging equipment that can effectively improve on the issue in a conventional charging equipment.

In order to solve the above-mentioned problems, one of the technical aspects adopted by the present disclosure is to provide a charging gun adapter. The charging gun adapter includes a housing, a first connection structure, a second connection structure, and a temperature protection structure. The first connection structure is disposed in the housing. The second connection structure is disposed in the housing, and the second connection structure is electrically coupled to the first connection structure to form a line unit. The temperature protection structure is electrically coupled to the line unit. When a temperature detected by the temperature protection structure is greater than a threshold value, the temperature protection structure and the line unit form a short circuit.

In order to solve the above-mentioned problems, another one of the technical aspects adopted by the present disclosure is to provide a charging equipment that includes a charging body, a charging gun, and a charging gun adapter. The charging gun is connected to the charging body. The charging gun adapter is electrically coupled to a charging nozzle of the charging gun. The charging gun adapter includes a housing, a first connection structure, a second connection structure, and a temperature protection structure. The first connection structure is disposed in the housing. The second connection structure is disposed in the housing, and the second connection structure is electrically coupled to the first connection structure to form a line unit. The temperature protection structure is electrically coupled to the line unit. When a temperature detected by the temperature protection structure is greater than a threshold value, the temperature protection structure and the line unit form a short circuit.

Therefore, in the charging gun adapter and charging equipment provided by the present disclosure, by virtue of “the temperature protection structure is electrically coupled to the line unit” and “when a temperature detected by the temperature protection structure is greater than a threshold value, the temperature protection structure and the line unit form a short circuit,” the purpose of overheating protection can be achieved.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The described embodiments may be better understood by reference to the following description and the accompanying drawings, in which:

FIG. 1 is a schematic view showing a structure of a charging equipment according to an embodiment of the present disclosure;

FIG. 2 is a schematic perspective view of a charging gun adapter according to the embodiment of the present disclosure;

FIG. 3 is a schematic front view of the charging gun adapter of FIG. 2;

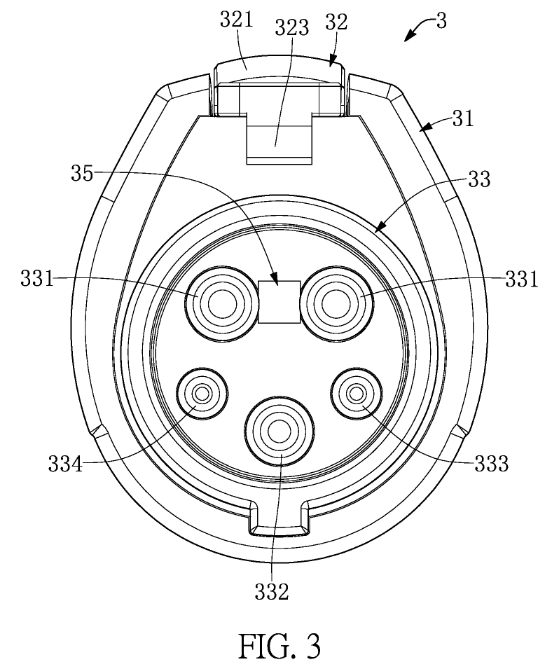

FIG. 4 is a schematic rear view of the charging gun adapter of FIG. 2;

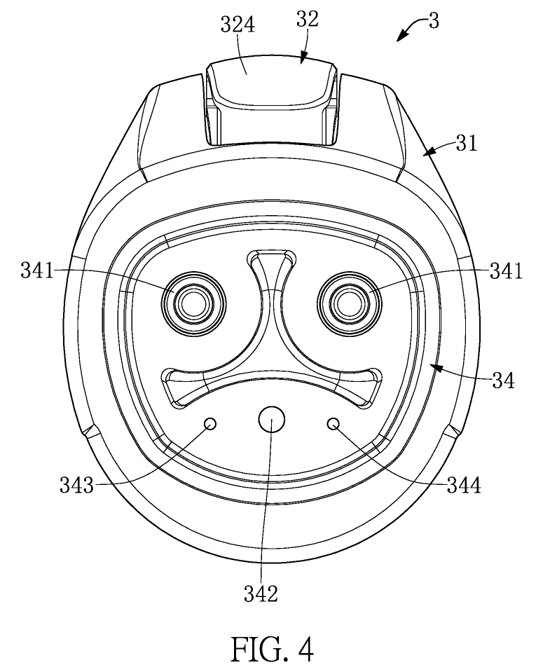

FIG. 5 is a schematic perspective cross-sectional view taken along line V-V of FIG. 2;

FIG. 6 is a schematic perspective cross-sectional view taken along line VI-VI of FIG. 2;

FIG. 7 is a partial schematic perspective cross-sectional view showing a subsequent operation of FIG. 6;

FIG. 8 is a schematic cross-sectional view taken along line VIII-VIII of FIG. 5;

FIG. 9 is a schematic cross-sectional view showing a subsequent operation of FIG. 8;

FIG. 10 is a schematic cross-sectional view taken along line VIII-VIII of FIG. 5 according to another embodiment of the present disclosure; and

FIG. 11 is a schematic cross-sectional view showing a subsequent operation of FIG. 10.

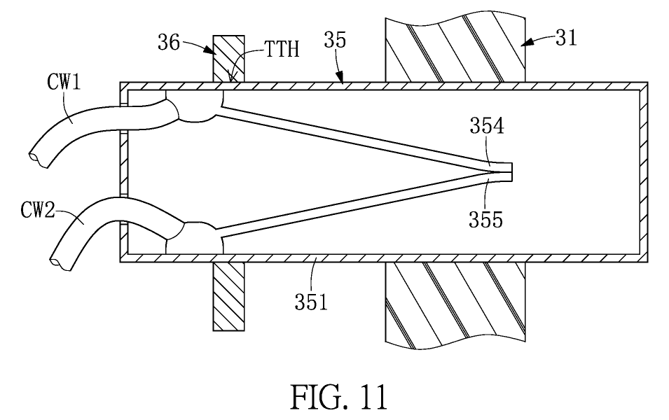

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a,” “an” and “the” includes plural reference, and the meaning of “in” includes “in” and “on.” Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first,” “second” or “third” can be used to describe various components, signals or the like, which are for distinguishing one component/signal from another one only, and are not intended to, nor should be construed to impose any substantive limitations on the components, signals or the like.

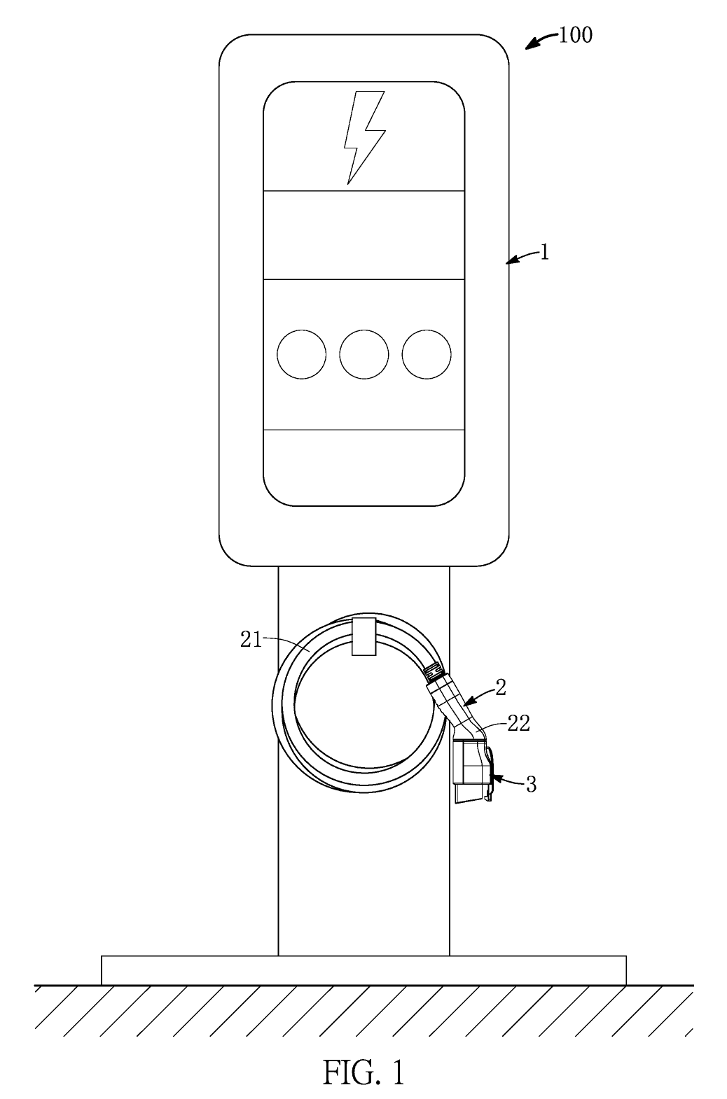

Referring to FIGS. 1 - 11, an embodiment of the present disclosure provides a charging equipment 100 that is configured to charge an electric vehicle (not shown in the drawings). In a process of charging the electric vehicle by the charging equipment 100 of the present embodiment, the charging equipment 100 is configured to sense whether a temperature during the charging process is too high (i.e., overheating). When the charging equipment 100 senses that an overheating phenomenon has occurred, the charging equipment 100 is immediately configured to stop charging the electric vehicle to achieve a purpose of overheating protection, thereby preventing a battery of the electric vehicle from catching fire.

It should be noted that, in order to facilitate understanding of the present embodiment, the drawings of the present embodiment only show a partial structure of the charging equipment 100 so as to clearly show the structure and connection relationship of each of the components of the charging equipment 100, but the present disclosure is not limited to what is shown in the drawings. The structure and the connection relationship of each of the components of the charging equipment 100 in the present embodiment will be introduced below.

As shown in FIGS. 1 - 3, the charging equipment 100 includes a charging body 1, a charging gun 2 that is connected to the charging body 1, and a charging gun adapter 3 that is electrically coupled to the charging gun 2. The charging body 1 is mainly a device for providing battery charging to plug-in electric vehicles (e.g., pure electric vehicles or plug-in hybrid electric vehicles).

In addition, the charging body 1 is capable of providing both for AC and DC charging. When the charging body 1 is capable of providing the DC charging, the charging body 1 is quickly configured to charge the electric vehicle. When the charging body 1 is capable of providing the AC charging, the charging body 1 is slowly configured to charge the electric vehicle. A detailed structure and functions of the charging body 1 are well known to those skilled in the art, and the present embodiment is not described herein for sake of brevity.

The charging gun 2 includes a charging cable 21 and a charging nozzle 22 that are located on opposite sides. The charging cable 21 has two ends located on opposite sides. One end of the charging cable 21 is electrically coupled to the charging body 1, and another one end of the charging cable 21 is electrically coupled to the charging gun 2. The charging cable 21 is designed for both power and signal transmission. This is a technique well known to those skilled in the art and is not further described in the present embodiment for sake of brevity.

The charging nozzle 22 is mainly connected to a charging socket of the electric vehicle (not shown in the drawings), so that the power provided by the charging body 1 is configured to be delivered to the electric vehicle for charging through the charging cable 21 and the charging nozzle 22. It should be noted that, in order for the charging nozzle 22 to be configured to connect to the charging socket of the electric vehicle, the charging nozzle 22 and the charging socket need to comply with corresponding charging connection specifications. The corresponding charging connection specifications between the charging nozzle 22 and the charging socket can generally be classified into a Type 1, a Type 2, a North American Charging Standard (NACS), a Combined Charging System 1 (CCS1), and a Combined Charging System 2 (CCS2).

The charging gun adapter 3 is electrically coupled to the charging nozzle 22 of the charging gun 2. It should be noted that, when the charging connection specification of the charging nozzle 2 of the charging gun 2 is different from the charging connection specification of the charging socket, the charging gun adapter 3 is connected to the charging nozzle 22 of the charging gun 2, so that the charging gun 2 is connected to the charging socket of the electric vehicle through the charging gun adapter 3, but the present disclosure is not limited thereto.

It should be noted that, in the present embodiment, a conversion type of the charging gun adapter 3 can be the conversion from the NACS to the Type 1, or from the Type 1 to the NACS, but the present disclosure is not limited thereto. For example, the conversion type of the charging gun adapter 3 can also be the conversion between the North American charging standards, or the charging gun adapter 3 can be designed according to actual requirements.

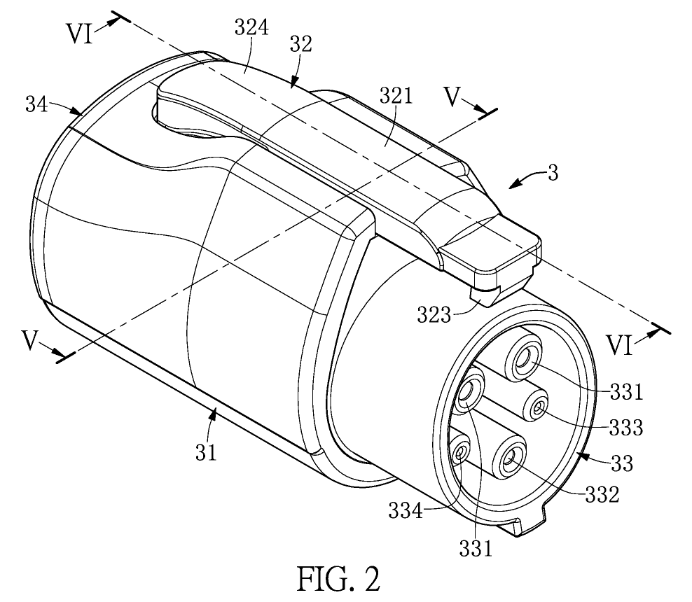

As shown in FIGS. 2 - 5, the charging gun adapter 3 includes a housing 31, a positioning structure 32 that is disposed in the housing 31, a first connection structure 33 that is disposed in the housing 31, a second connection structure 34 that is disposed in the housing 31, and a temperature protection structure 35.

When the charging gun adapter 3 is connected to the charging socket of the electric vehicle, the positioning structure 32 is fixed to the charging socket, so that the charging gun adapter 3 is fixedly connected to the charging socket.

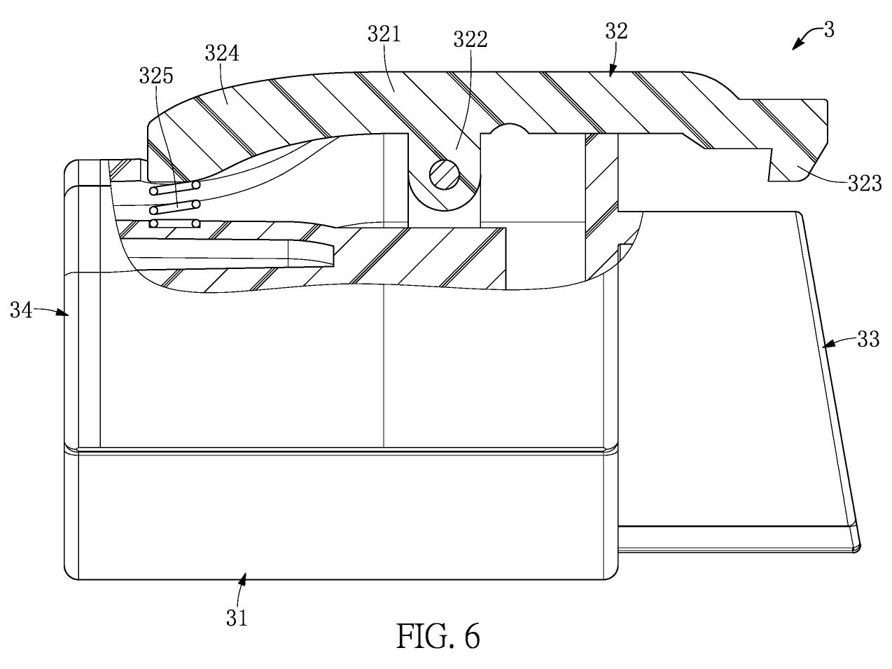

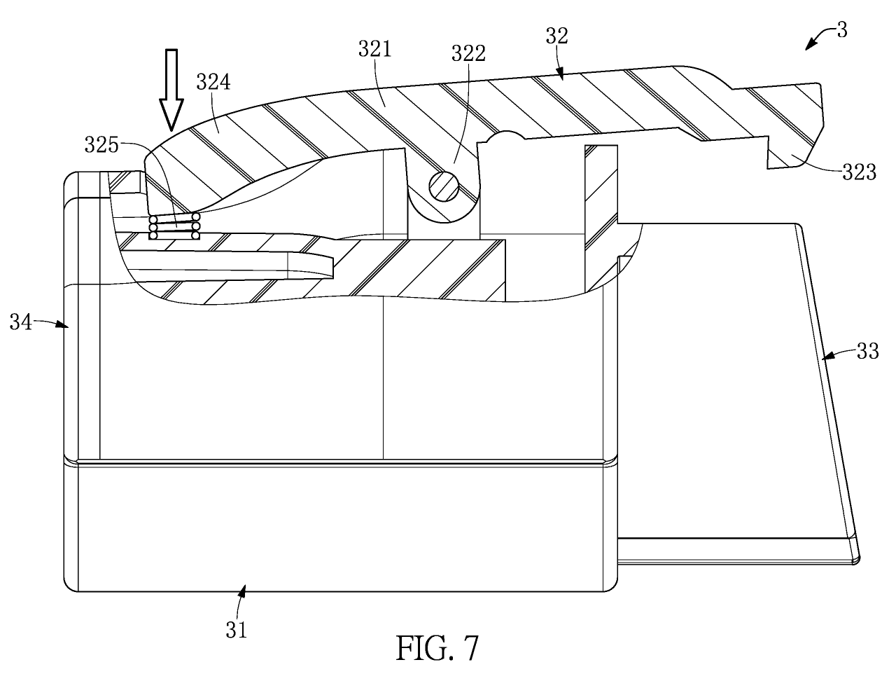

More specifically, as shown in FIGS. 6 and 7, the positioning structure 32 includes a positioning body 321, a pivoting portion 322 that is pivotally connected to positioning body 321, a hook 323 that is disposed on the positioning body 321, a pressing portion 324 that is disposed on the positioning body 321, and an elastic portion 325 that is disposed on the pressing portion 324. The pivoting portion 322 is disposed in a middle region of the positioning body 321 and is arranged on a side of the positioning body 321 facing the housing 31, such that the positioning body 321 is rotatable upward or downward about the pivoting portion 322 (as an axis).

The hook 323 is arranged on one end of the positioning body 321, and the hook 323 is protruded on the side facing the first connection structure 33, so that when the charging gun adapter 3 is connected to the charging socket of the electric vehicle, the hook 323 is engaged with the charging socket.

The pressing portion 324 and the hook 323 are respectively arranged on opposite sides of the pivoting portion 322. The pressing portion 324 is configured to be pressed to move the hook 323 between a locking position (as shown in FIG. 6) and an unlocking position (as shown in FIG. 7). Specifically speaking, when the pressing portion 324 is not pressed, the hook 323 is located on the locking position to be fixed to the charging socket. When the pressing portion 324 is pressed, the pressing portion 324 is configured to rotate downward with the pivoting portion 322 as the axis, and the hook 323 is configured to rotate upward with the pivoting portion 322 as the axis to move to the unlocking position to disengage from the charging socket.

The elastic portion 325 is disposed below the pressing portion 324 to restore the pressing portion 324 to an original position. More specifically, when the pressing portion 324 is pressed, the elastic portion 325 is maintained in a compressed state by the pressing portion 324 (as shown in FIG. 7). After the pressing portion 324 is released from being pressed, the elastic portion 325 returns upward, thereby allowing the pressing portion 324 to return to its original position (as shown in FIG. 6).

As shown in FIGS. 2 - 5, the first connection structure 33 is configured to connect the charging socket of the electric vehicle, so that the charging body 1 is configured to charge the electric vehicle. In the present embodiment, the first connection structure 33 includes two first power terminals 331, a first grounding terminal 332, a first control terminal 333, and a first charging state terminal 334. The two first power terminals 331 provide a passage for a power output from the charging body 1 (as shown in FIG. 1), thereby enabling the charging body 1 to charge the electric vehicle. The first grounding terminal 332 is connected to a grounding terminal of the charging socket.

The first control terminal 333 is configured to provide a communication channel between the charging body 1 and the electric vehicle, so that a control signal is transmitted between the charging body 1 and the electric vehicle through the first control terminal 333.

The first charging state terminal 334 is configured to monitor and transmit a state information of the electric vehicle during the charging process (e.g., whether charging is in progress between the charging body 1 and the electric vehicle, whether charging is complete, or if there are any abnormal conditions).

The second connection structure 34 is located on an opposite side of the first connection structure 33 of the housing 31. In the present embodiment, the second connection structure 34 is connected to the charging nozzle 22 of the charging gun 2 to convert the charging connection specification of the charging gun 2. The second connection structure 34 is electrically coupled to the first connection structure 33 to form a line unit 37. The second connection structure 34 includes two second power terminals 341, a second grounding terminal 342, a second control terminal 343 and a second charging state terminal 344.

The two second power terminals 341 are respectively and electrically coupled to the two first power terminals 331 to form two charging lines. The two charging lines are configured to transmit the power to the electric vehicle for charging. The second grounding terminal 342 is electrically coupled to the first grounding terminal 332 to form a grounding line 371.

The second control terminal 343 is electrically coupled to the first control terminal 333 to form a control line 372. The control line 372 is configured to provide the communication channel between the charging body 1 and the electric vehicle, so that the control signal is transmitted between the charging body 1 and the electric vehicle through the control line 372.

The second charging state terminal 344 is electrically coupled to the first charging state terminal 334 to form a charging state line. The charging state line is configured to monitor and transmit the state information of the electric vehicle during the charging process (e.g., whether charging is in progress between the charging body 1 and the electric vehicle, whether charging is complete, or if there are any abnormal conditions).

It should be noted that, the line unit 37 includes the control line 372 and the grounding line 371, but the present disclosure is not limited thereto. For example, the line unit 37 can include the charging state line and the grounding line 371 according to actual design requirements.

As shown in FIGS. 2 - 5, the temperature protection structure 35 is electrically coupled to the line unit 37 (i.e., the grounding line 371 and the control line 372) to form an open circuit. When a temperature detected by the temperature protection structure 35 is greater than a threshold value, the temperature protection structure 35 and the line unit 37 form a short circuit. More specifically, the temperature protection structure 35 is disposed at any position on the housing 31 adjacent to either of the two charging lines to sense the temperature generated by the two charging lines. Specifically speaking, the temperature protection structure 35 is configured to be disposed between the first connection structure 33 and the second connection structure 34 and is arranged on a middle area of the two charging lines, so as to accurately sense the temperature generated by the two charging lines, but the present disclosure is not limited thereto. For example, an installation position of the temperature protection structure 35 can be adjusted and changed according to practical requirements.

In the present embodiment, the charging gun adapter 3 further includes a heat conduction sheet 36. The heat conduction sheet 36 is fixedly disposed on the housing 31, and the heat conduction sheet 36 has two power through holes PTH and a temperature through hole TTH. The two PTHs are respectively provided for the two charging lines to pass through, and the TTH is provided for the temperature protection structure 35 to pass through.

In practice, the heat conduction sheet 36 is made of metal. The two power through holes PTH are respectively penetrated by the two charging lines, and the temperature through hole TTH is penetrated by the temperature protection structure 35, thereby enabling the temperature protection structure 35 to sense the temperature generated by the two charging lines through the heat conduction sheet 36, but the present disclosure is not limited thereto. For example, the heat conduction sheet 36 can be changed or omitted according to actual design requirements.

The temperature protection structure 35 in the present embodiment has two connecting wires CW1, CW2, and one of the two connecting wires CW1, CW2 is electrically coupled to the control line 372; and another one of the two connecting wires CW1, CW2 is electrically coupled to the grounding line 371. When the temperature on the two charging lines is less than the threshold value, the temperature protection structure 35, the grounding line 371, and the control line 372 are formed to the open circuit. That is to say, the grounding line 371 and the control line 372 are not electrically coupled to each other through the temperature protection structure 35. At this time, the charging gun 2 of the charging body 1 can normally charge the electric vehicle through the two charging lines of the charging gun adapter 3.

When the temperature on the two charging lines is greater than the threshold value, the temperature protection structure 35, the grounding line 371, and the control line 372 form the short circuit. That is to say, the grounding line 371 and the control line 372 are electrically coupled to each other through the temperature protection structure 35. At this time, the charging gun 2 of the charging body 1 is configured to stop charging the electric vehicle so as to achieve a purpose of overheating protection.

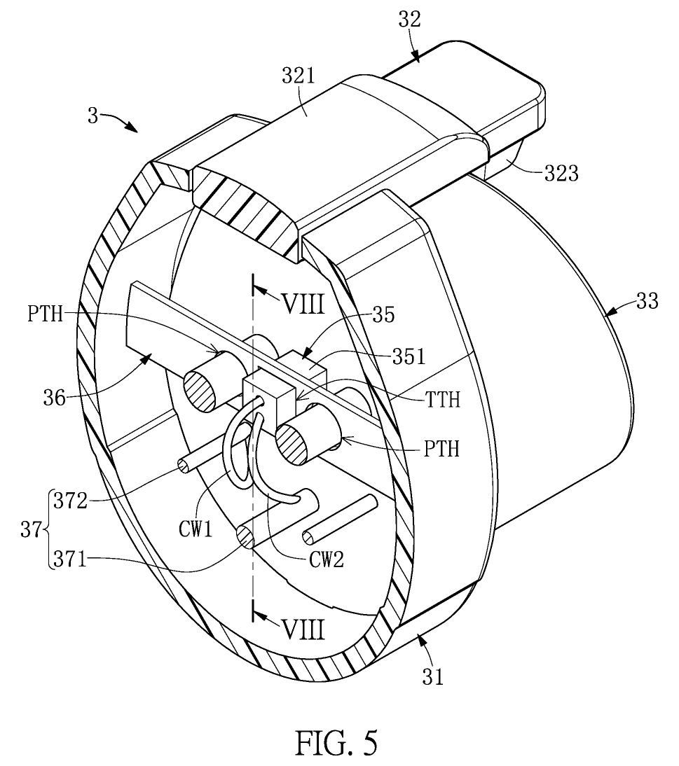

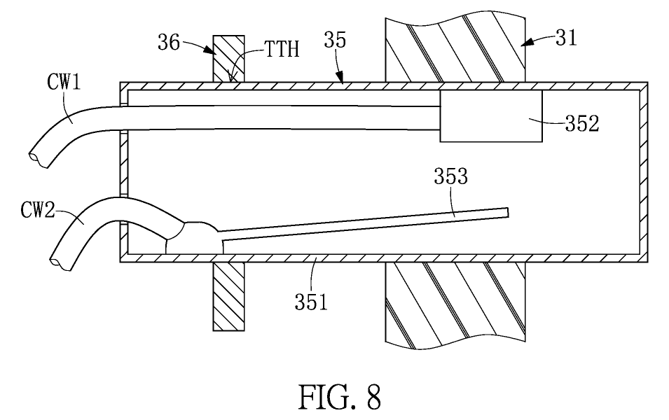

As shown in FIGS. 5, 8, and 9, the temperature protection structure 35 includes a casing 351, a metal block 352 that is disposed in the casing 351, and a metal elastic piece 353 that is disposed in the casing 351. In the present embodiment, the metal block 352 is fixedly disposed in the casing 351, the metal block 352 is electrically coupled to the connecting wire CW1 of the two connecting wires CW1, CW2. The metal elastic piece 353 is electrically coupled to the connecting wire CW2 of the two connecting wires CW1, CW2. When the temperature on the two charging lines is less than the threshold value, the metal elastic piece 353 and the metal block 352 are electrically coupled to each other (as shown in FIG. 8), so that the charging gun 2 of the charging body 1 can normally charge the electric vehicle through the two charging lines of the charging gun adapter 3.

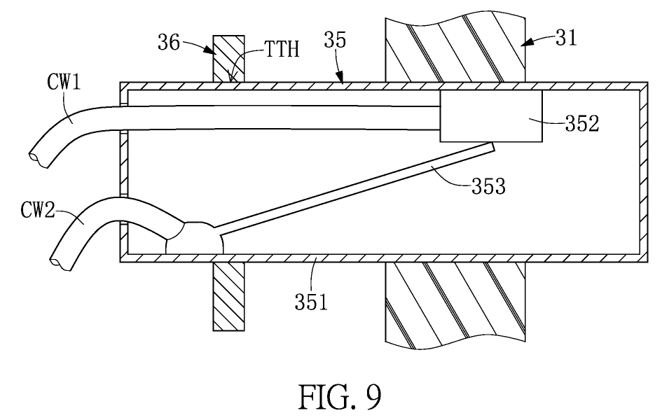

When the temperature on the two charging lines is greater than the threshold value, the metal elastic piece 353 is deformed by heat to be electrically coupled to the metal block 352, so as to form the short circuit (as shown in FIG. 9). That is to say, the metal elastic piece 353 is electrically coupled to the metal block 352, so that the grounding line 371 and the control line 372 are electrically coupled to each other. At this time, the charging gun 2 of the charging body 1 is configured to stop charging the electric vehicle to achieve the purpose of overheating protection.

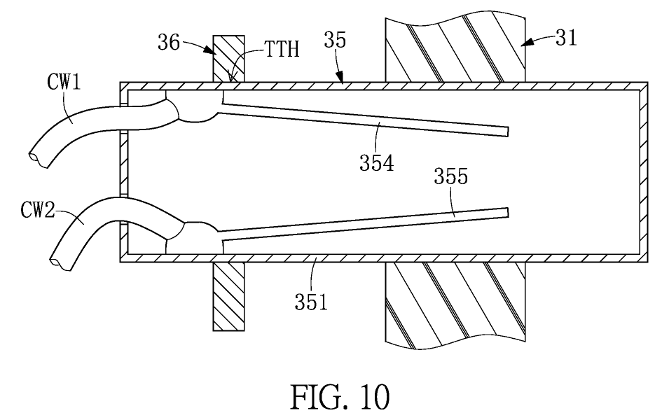

As shown in FIGS. 10 - 11, a second embodiment of the temperature protection structure 35 of the present disclosure, which is similar to the temperature protection structure 35 of the above-mentioned first embodiment, is provided. For the sake of brevity, descriptions of the same components in the first and second embodiments of the present disclosure will be omitted herein, and the following description only discloses different features between the first and second embodiments.

The temperature protection structure 35 of the present embodiment includes a first metal sheet 354 and a second metal sheet 355. The first metal sheet 354 is disposed in the casing 351. The second metal sheet 354 is electrically coupled to the connecting wire CW1 of the two connecting wires CW1, CW2. In the present embodiment, the first metal sheet 354 can sense that the temperature is greater than the threshold value, and the first metal sheet 354 is deformed.

The second metal sheet 355 is disposed in the casing 351. The second metal sheet 355 is electrically coupled to the connecting wire CW2 of the two connecting wires CW1, CW2. In the present embodiment, the second metal sheet 355 can sense that the temperature is greater than the threshold value, and the second metal sheet 355 is deformed.

In summary, when the temperature on the two charging lines is greater than the threshold value, the first metal sheet 354 and the second metal sheet 355 are deformed by heat to be electrically coupled to each other so as to form the short circuit. That is to say, the first metal sheet 354 is electrically coupled to the second metal sheet 355, so that the grounding line 371 and the control line 372 are electrically coupled to each other. At this time, the charging gun 2 of the charging body 1 is configured to stop charging the electric vehicle to achieve the purpose of overheating protection.

### Beneficial Effects of the Embodiment

In conclusion, in the charging gun adapter and charging equipment provided by the present disclosure, by virtue of “the temperature protection structure is electrically coupled to the line unit” and “when a temperature detected by the temperature protection structure is greater than a threshold value, the temperature protection structure and the line unit form a short circuit,” the purpose of overheating protection can be achieved.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. A charging gun adapter, comprising:
a housing;
a first connection structure disposed in the housing;
a second connection structure disposed in the housing, wherein the second connection structure is electrically coupled to the first connection structure to form a line unit; and
a temperature protection structure electrically coupled to the line unit;
wherein, when a temperature detected by the temperature protection structure is greater than a threshold value, the temperature protection structure and the line unit form a short circuit.

2. The charging gun adapter according to claim 1, wherein the first connection structure includes two first power terminals, a first grounding terminal, and a first control terminal; wherein the second connection structure includes two second power terminals, a second grounding terminal, and a second control terminal; and wherein the two first power terminals are respectively and electrically coupled to the two second power terminals to form two charging lines, the first grounding terminal is electrically coupled to the second grounding terminal to form a grounding line, and the first control terminal is electrically coupled to the second control terminal to form a control line.

3. The charging gun adapter according to claim 2, wherein the line unit includes the control line and the grounding line, and wherein, when the temperature detected by the temperature protection structure is greater than the threshold value, the control line and the grounding line form the short circuit through the temperature protection structure.

4. The charging gun adapter according to claim 2, wherein the temperature protection structure is disposed at any position on the housing adjacent to either of the two charging lines; and wherein the temperature protection structure has two connecting wires, one of the two connecting wires being electrically coupled to the control line, and another one of the two connecting wires being electrically coupled to the grounding line.

5. The charging gun adapter according to claim 2, wherein the temperature protection structure is disposed between the first connection structure and the second connection structure and is arranged on a middle area of the two charging lines.

6. The charging gun adapter according to claim 2, wherein the charging gun adapter further includes a heat conduction sheet, the heat conduction sheet has two power through holes and a temperature through hole, and wherein the two power through holes are provided for the two charging lines to pass through, and the temperature through hole is provided for the temperature protection structure to pass through.

7. The charging gun adapter according to claim 4, wherein the temperature protection structure includes:
a casing;
a metal block disposed in the casing, wherein the metal block is electrically coupled to one of the two connecting wires; and
a metal elastic piece disposed in the casing, wherein the metal elastic piece is electrically coupled to another one of the two connecting wires.

8. The charging gun adapter according to claim 7, wherein, when the temperature on the two charging lines is greater than the threshold value, the metal elastic piece is deformed by heat to be electrically coupled to the metal block, so as to form the short circuit.

9. The charging gun adapter according to claim 4, wherein the temperature protection structure includes:
a casing;
a first metal sheet disposed in the casing, wherein the first metal sheet is electrically coupled to one of the two connecting wires; and
a second metal sheet disposed in the casing, wherein the second metal sheet is electrically coupled to another one of the two connecting wires;
wherein, when the temperature on the two charging lines is greater than the threshold value, the first metal sheet and the second metal sheet are deformed by heat to be electrically coupled to each other, so as to form the short circuit.

10. The charging gun adapter according to claim 1, wherein the charging gun adapter further includes a positioning structure that is connected to the housing, the positioning structure includes:
a positioning body;
a pivoting portion pivotally connected to the positioning body;
a hook arranged on one end of the positioning body, wherein the hook is protruded on the side facing the first connection structure; and
a pressing portion, the pressing portion and the hook being respectively arranged on opposite sides of the pivoting portion.

11. The charging gun adapter according to claim 10, wherein the pressing portion is configured to be pressed to allow the hook to move between a locking position and an unlocking position.

12. The charging gun adapter according to claim 10, wherein the positioning structure further includes an elastic portion, and wherein the elastic portion is disposed below the pressing portion to restore the pressing portion to an original position.

13. A charging equipment, comprising:
a charging body;
a charging gun connected to the charging body; and
a charging gun adapter electrically coupled to a charging nozzle of the charging gun; wherein the charging gun adapter includes:
a housing;
a first connection structure disposed in the housing;
a second connection structure disposed in the housing, wherein the second connection structure is electrically coupled to the first connection structure to form a line unit; and
a temperature protection structure electrically coupled to the line unit;
wherein, when a temperature detected by the temperature protection structure is greater than a threshold value, the temperature protection structure and the line unit form a short circuit.

14. The charging equipment according to claim 13, wherein the first connection structure includes two first power terminals, a first grounding terminal, and a first control terminal; wherein the second connection structure includes two second power terminals, a second grounding terminal, and a second control terminal; and wherein the two first power terminals are respectively and electrically coupled to the two second power terminals to form two charging lines, the first grounding terminal is electrically coupled to the second grounding terminal to form a grounding line, and the first control terminal is electrically coupled to the second control terminal to form a control line.

15. The charging equipment according to claim 14, wherein the line unit includes the control line and the grounding line, and wherein, when the temperature detected by the temperature protection structure is greater than the threshold value, the control line and the grounding line form the short circuit through the temperature protection structure.

16. The charging equipment according to claim 14, wherein the temperature protection structure is disposed at any position on the housing adjacent to either of the two charging lines; and wherein the temperature protection structure has two connecting wires, one of the two connecting wires being electrically coupled to the control line, and another one of the two connecting wires being electrically coupled to the grounding line.

17. The charging equipment according to claim 14, wherein the temperature protection structure is disposed between the first connection structure and the second connection structure and is arranged on a middle area of the two charging lines.

18. The charging equipment according to claim 14, wherein the charging gun adapter further includes a heat conduction sheet, the heat conduction sheet has two power through holes and a temperature through hole, and wherein the two power through holes are provided for the two charging lines to pass through, and the temperature through hole is provided for the temperature protection structure to pass through.

19. The charging equipment according to claim 16, wherein the temperature protection structure includes:
a casing;
a metal block disposed in the casing, wherein the metal block is electrically coupled to one of the two connecting wires; and
a metal elastic piece disposed in the casing, wherein the metal elastic piece is electrically coupled to another one of the two connecting wires.

20. The charging equipment according to claim 19, wherein, when the temperature on the two charging lines is greater than the threshold value, the metal elastic piece is deformed by heat to be electrically coupled to the metal block, so as to form the short circuit.

21. The charging equipment according to claim 16, wherein the temperature protection structure includes:
a casing;
a first metal sheet disposed in the casing, wherein the first metal sheet is electrically coupled to one of the two connecting wires; and
a second metal sheet disposed in the casing, wherein the second metal sheet is electrically coupled to another one of the two connecting wires;
wherein, when the temperature on the two charging lines is greater than the threshold value, the first metal sheet and the second metal sheet are deformed by heat to be electrically coupled to each other so as to form the short circuit.

22. The charging equipment according to claim 13, wherein the charging gun adapter further includes a positioning structure that is connected to the housing, the positioning structure includes:
a positioning body;
a pivoting portion pivotally connected to the positioning body;
a hook arranged on one end of the positioning body, wherein the hook is protruded on the side facing the first connection structure; and
a pressing portion, the pressing portion and the hook being respectively arranged on opposite sides of the pivoting portion.

23. The charging equipment according to claim 22, wherein the pressing portion is configured to be pressed to allow the hook to move between a locking position and an unlocking position.

24. The charging equipment according to claim 22, wherein the positioning structure further includes an elastic portion, and wherein the elastic portion is disposed below the pressing portion to restore the pressing portion to an original position.
